(19) United States
(12) Patent Application Publication
(10) Pub. No.: US 2019/0085601 A1
(43) Pub. Date: Mar. 21, 2019

(54) VEHICLE DOOR LOCK DEVICE

(71) Applicant: AISIN SEIKI KABUSHIKI KAISHA, Kariya-shi (JP)

(72) Inventors: Kazunori KOJIMA, Nagoya-shi (JP); Yoshiki ODAKA, Obu-shi (JP); Yusuke YAMADA, Kariya-shi (JP); Naoto NONOMURA, Kariya-shi (JP); Eiji TORII, Aichi-ken (JP)

(73) Assignee: AISIN SEIKI KABUSHIKI KAISHA, Kariya-shi (JP)

(21) Appl. No.: 16/114,492

(22) Filed: Aug. 28, 2018

(30) Foreign Application Priority Data
Sep. 19, 2017 (JP) 2017-178473

(51) Int. Cl. E05B 83/36; E05B 85/02; E05B 79/16

(52) U.S. Cl. CPC E05B 83/36; E05B 81/06; E05B 79/16; E05B 85/02

(57) ABSTRACT

A vehicle door lock device includes: a latch rotatable to a full latch position at which the latch is engaged with a striker, an unlatch position at which the latch releases the striker, and a half latch position between the full latch position and the unlatch position and at which the latch is engaged with the striker; a pawl rotatable between an engagement position at which the pawl is engaged with the latch located at the full latch position and a non-engagement position at which the pawl releases the engagement with the latch; and a block lever rotatable between a rotation restriction position at which the block lever is engaged with the pawl to hold the pawl at the engagement position and a rotation non-restriction position at which the block lever does not restrict the rotation of the pawl.

### CROSS REFERENCE TO RELATED APPLICATIONS

This application is based on and claims priority under 35 U.S.C. § 119 to Japanese Patent Application 2017-178473, filed on Sep. 19, 2017, the entire contents of which are incorporated herein by reference.

### TECHNICAL FIELD

This disclosure relates to a vehicle door lock device provided in a vehicle door.

### BACKGROUND DISCUSSION

A vehicle generally includes a vehicle body and a vehicle door, which opens and closes a door opening formed in the side surface of the vehicle body. Then, a striker is provided on the vehicle body so as to protrude therefrom, and a door lock device is provided in the vehicle door.

US 2014/0291998 A (Reference 1) discloses an exemplary door lock device.

The door lock device includes a base member. The base member is fixed to the vehicle door.

In addition, a latch, a pawl, and a block lever (blocking lever) are rotatably supported on the base member.

The latch is supported on the base member so as to be rotatable between a full latch position, at which the latch is engageable with the striker, and an unlatch position at which the latch is not engaged with the striker. In addition, the latch is rotatable to a half latch position between the full latch position and the unlatch position. The latch is urged to rotate toward the unlatch position by the urging force of a first urging unit.

The pawl is supported on the base member so as to be rotatable between an engagement position and a non-engagement position. In addition, the pawl is urged to rotate toward the engagement position by the urging force of a second urging unit.

The block lever is supported on the base member so as to be rotatable between an initial rotation position and a half-latch holding position. In addition, the block lever is urged to rotate toward the initial rotation position by the urging force of a third urging unit.

In addition, the door lock device includes a lock release lever. The lock release lever is associated with the block lever and an operation handle, which is rotatably supported on the vehicle door.

When the vehicle door is located at a completely closed position at which the vehicle door closes the door opening formed in the side surface of the vehicle body, the striker fixed to the vehicle body is engaged with the latch, so that the latch is rotated to the full latch position by the striker.

Thereby, the pawl rotates to the engagement position, and is engaged with the latch. Thereby, rotation of the latch toward the unlatch position is restricted by the pawl.

In addition, the block lever rotates to a predetermined position between the initial rotation position and the half-latch holding position, and is engaged with the pawl. Thereby, rotation of the pawl toward the non-engagement position is restricted by the block lever.

When the vehicle door is at the completely closed position as described above, the latch is held at the full latch position by the pawl and the block lever. That is, the door lock device enters a fully latched state.

Since the rotation of the latch toward the unlatch position is firmly restricted by two members including the pawl and the block lever, even if a large force in the opening direction is applied to the vehicle door, there is little possibility of the latch rotating toward the unlatch position.

Meanwhile, when rotating the operation handle while the latch, the pawl, and the block lever are in the fully latched state, the lock release lever rotates. Thereby, the block lever, which is associated with the lock release lever, rotates to the initial rotation position while releasing the engagement with the pawl. Therefore, when rotating the vehicle door in the opening direction, the latch releases the striker, and rotates to the unlatch position while rotating the pawl to the non-engagement position. That is, the door lock device enters an unlatched state.

In addition, when rotating the vehicle door to the vicinity of the completely closed position, the latch reaches the half latch position.

Then, for example, when stopping the rotation of the vehicle door once the latch has reached the half latch position, the block lever moves to the half-latch holding position, and is engaged with the latch. Thereby, the rotation of the latch toward the unlatch position is restricted by the block lever. In addition, at this time, the pawl, which has been urged to rotate toward the engagement position, is engaged with the block lever, thereby restricting the rotation of the block lever to the initial rotation position. That is, the door lock device enters a half latched state.

In this state, for example, when the vehicle door is further rotated with a strong force in the closing direction, the vehicle door rotates to the completely closed position, and the door lock device enters the fully latched state.

As described above, when the door lock device enters the half latched state, two members, including the pawl and the block lever, hold the latch at the half latch position. In other words, a rotational position (half-latch holding position) of the block lever for holding the latch at the half latch position is controlled by the pawl.

However, it is not easy to highly precisely control the rotational position of the block lever, which receives the urging force of the third urging unit and is engaged with the latch (located at the half latch position), using the pawl.

Thus, a need exists for a vehicle door lock device which is not susceptible to the drawback mentioned above.

### SUMMARY

An aspect of this disclosure is directed to a vehicle door lock device including a latch configured to be rotatable to a full latch position at which the latch is engaged with a striker attached to a vehicle body to hold a vehicle door in a closed state, an unlatch position at which the latch releases the striker to allow the vehicle door to enter an open state, and a half latch position which is a position between the full latch position and the unlatch position and at which the latch is engaged with the striker, a pawl configured to be rotatable between an engagement position at which the pawl is engaged with the latch located at the full latch position and a non-engagement position at which the pawl releases the engagement with the latch, and a block lever configured to be rotatable between a rotation restriction position at which the block lever is engaged with the pawl to hold the pawl at the engagement position and a rotation non-restriction position at which the block lever does not restrict the rotation of the pawl, wherein, when the latch is located at the half latch position, the latch is engaged with the block lever while applying a force in a direction that passes through a rotation axis of the block lever, or wherein, when the latch is located at the half latch position, the latch is engaged with the pawl while applying a force in a direction that passes through a rotation axis of the pawl.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle door, equipped with a door lock device according to a first embodiment disclosed here, when viewed from the vehicle outer side;

FIG. 2 is a rear view of the door lock device when a latch is located at an unlatch position;

FIG. 3 is a front view of the door lock device, from which some members are omitted, when a lock knob is located at a lock position and the latch is located at a full latch position;

FIG. 4 is a front view of the door lock device, from which some members are omitted, when the lock knob is located at an unlock position and the latch is located at the full latch position;

FIG. 5 is a rear view of the door lock device when the latch is located at a half latch position;

FIG. 6 is a rear view of the door lock device when the latch is located at the full latch position;

FIG. 7 is a rear view of the door lock device for explaining the magnitude of an operation force required for shifting the lock device from a fully latched state to an unlatched state;

FIG. 8 is a front view similar to FIG. 4 when a lift lever exerts a cancel function;

FIG. 9 is a rear view of a door lock device according to a second embodiment disclosed here when a latch is located at an unlatch position;

FIG. 10 is a rear view of the door lock device when the latch is located at a half latch position; and

FIG. 11 is a rear view of the door lock device when the latch is located at a full latch position.

### DETAILED DESCRIPTION

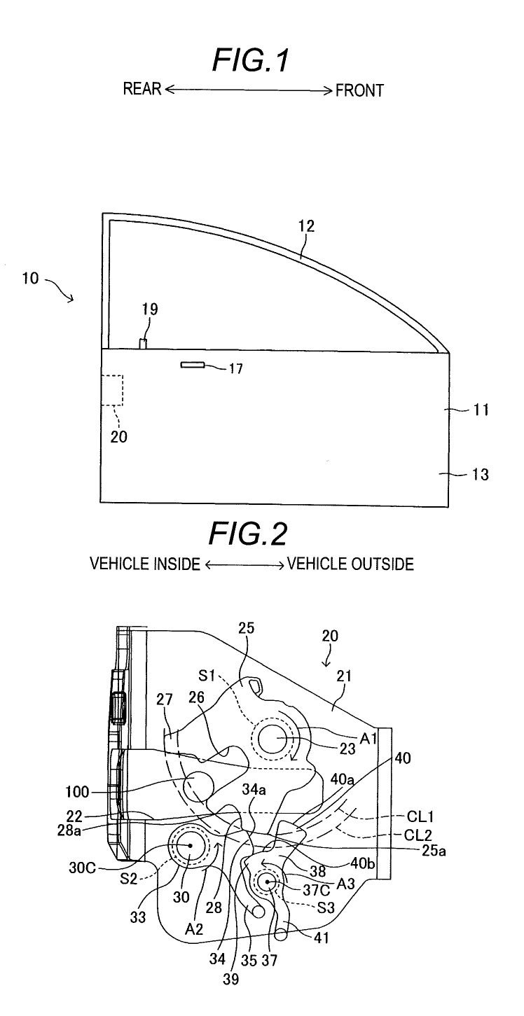

Hereinafter, a first embodiment disclosed here will be described with reference to FIGS. 1 to 8.

A vehicle door 10 of a vehicle illustrated in FIG. 1 is a side door, and a front end portion thereof is supported on a vehicle body (not illustrated) so as to be rotatable around a vertical rotation axis. The vehicle door 10 is horizontally rotatable relative to the vehicle body between a completely opened position, at which the vehicle door completely opens an opening formed in the side surface of the vehicle body (not illustrated), and a completely closed position at which the vehicle door completely closes the opening. In addition, the terms “front-and-rear direction” and “vehicle inside-and-outside direction” in the following description are directions based on a case where the vehicle door 10 is located at the completely closed position.

The vehicle door 10 includes a door body unit 11 constituting a lower half portion thereof and a door sash 12 provided at an upper half portion thereof. The door body unit 11 includes an outer panel 13, which constitutes the outer surface of the door body unit 11, an inner panel (not illustrated), which is fixed to the inner surface of the outer panel 13, and a resin trim (not illustrated), which is fixed to the inner surface of the inner panel and constitutes the inner surface of the door body unit 11.

An outside handle 13 is rotatably supported on the outer panel 13. The outside handle 17 is rotatable between an initial position and a latch release position, and is urged to rotate toward the initial position by the urging force of a torsion coil spring S4 to be described later.

In addition, a lock knob 19 is provided on the upper end portion of the trim so as to be slidable in the vertical direction. The lock knob 19 is slidable relative to the trim between an unlock position (the position in FIG. 1) and a lock position (not illustrated) located below the unlock position.

A door lock device 20 is provided in the vehicle door 10 in a manner such that the door lock device 20 is located between the outer panel 13 and the inner panel and a portion thereof is exposed from the rear end surface of the vehicle door 10.

As illustrated in FIGS. 2 to 8, the door lock device 20 includes, as major components, a base member 21, a latch 25, a pawl 33, a block lever 38, a lift lever 43 (rotator), an outside open lever 47, and an open link 51 (block lever operation element).

The base member 21 rotatably supports the latch 25, the pawl 33, the block lever 38, and the outside open lever 47.

As illustrated in FIGS. 2, 5, 6, and 7, a striker introduction groove 22 is formed in the base member 21. The end portion of the striker introduction groove 22 on the vehicle inner side is open.

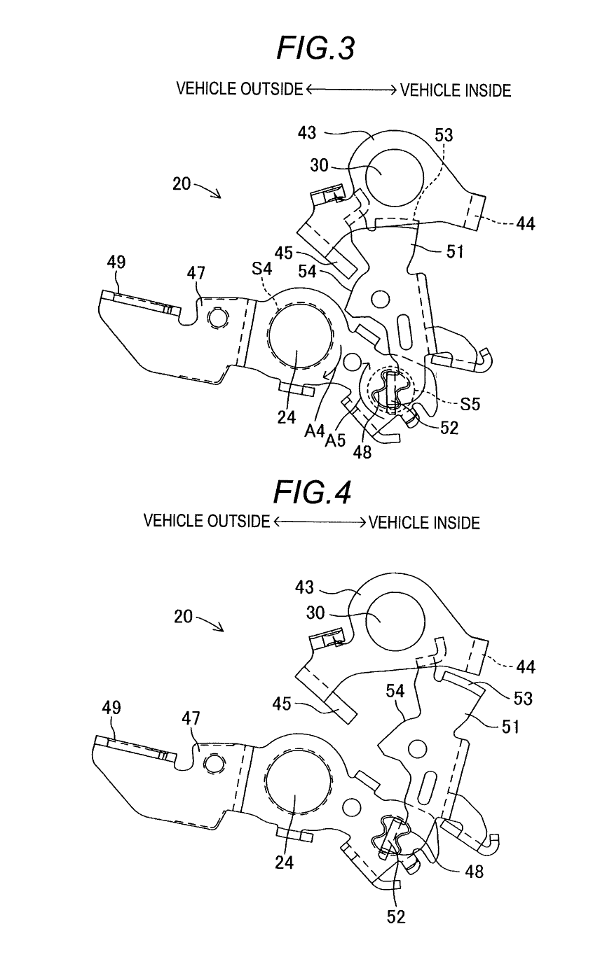

As illustrated in FIGS. 3, 4, and 8, the base member 21 includes a cylindrical open lever support portion 24, which extends forward.

As illustrated in FIGS. 2, 5, 6, and 7, the latch 25, which is disengageable from a striker 100 fixed to the vehicle body, includes a striker holding groove 26, into which the striker 100 may be introduced. In addition, the outer peripheral portion of the latch 25 is formed with a full-latch engagement target portion 27 and a disengagement groove 28. A first urging portion 25a is formed on the end portion of the outer peripheral surface of a region of the latch 25 in which the disengagement groove 28 is formed. In addition, a second urging portion 28a and a half-latch engagement portion 28b are formed on the inner surface of the disengagement groove 28. The latch 25 may be formed of a metal, for example.

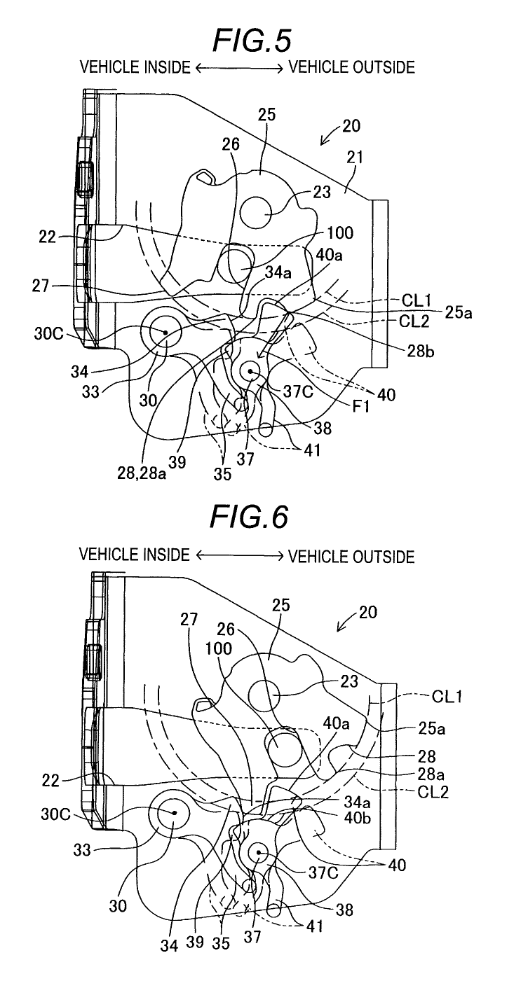

A metal latch support shaft 23 penetrates a portion of the base member 21 in the front-and-rear direction. Then, the latch support shaft 23 supports the latch 25 so as to enable relative rotation thereof. Therefore, the latch 25 is rotatable relative to the base member 21 between a full latch position (see FIGS. 6 and 7) at which the striker holding groove 26 is engaged with the striker 100 and an unlatch position (see FIG. 2) at which the striker holding groove 26 releases the striker 100. In addition, when rotating between the unlatch position and the full latch position, the latch 25 passes through a half latch position (see FIG. 5), which is located between the unlatch position and the full latch position.

In addition, a torsion coil spring S1 (latch urging element) illustrated in FIG. 2 is mounted between the latch 25 and the base member 21. The latch 25 is urged to rotate toward the unlatch position (the direction of arrow A1 in FIG. 2) by the urging force generated by the torsion coil spring S1.

As illustrated in FIGS. 2, 5, 6, and 7, the pawl 33, which is disengageable from the latch 25, includes an engagement protrusion 34 and an urging target portion 35. The pawl 33 may be formed of a metal, for example.

A metal pawl support shaft 30 penetrates a portion of the base member 21 in the front-and-rear direction. Then, the pawl support shaft 30 supports the pawl 33 so as to enable relative rotation thereof. The latch 25 and the pawl 33 have the same position in the front-and-rear direction. The pawl 33 is rotatable relative to the base member 21 around the pawl support shaft 30 between an engagement position (see solid lines in FIGS. 5 and 6 and FIGS. 2 and 7) at which the engagement protrusion 34 is engaged with the latch 25 located at the full latch position to hold the latch 25 at the full latch position and a non-engagement position (see dotted lines in FIGS. 5 and 6) at which the engagement protrusion 34 is spaced apart from the latch 25.

As illustrated in FIGS. 2 and 5 to 7, the outer peripheral surface of the engagement protrusion 34 is configured with an arc-shaped surface 34a. The center of curvature 34aC of the arc-shaped surface 34a (see FIG. 7) is spaced apart from an axis 30C of the pawl support shaft 30 by a predetermined distance (distance Ra to be described later).

In addition, a torsion coil spring S2 (pawl urging element) illustrated in FIG. 2 is mounted between the pawl 33 and the base member 21. The pawl 33 is urged to rotate toward the engagement position (the direction of arrow A2 in FIG. 2) by the urging force generated by the torsion coil spring S2. In addition, a pawl stopper (not illustrated) is provided on the base member 21. When the pawl 33 is brought into contact with the pawl stopper by the urging force generated by the torsion coil spring S2, the pawl 33 is located at the engagement position.

As illustrated in FIGS. 2, 5, 6, and 7, the block lever 38, which is disengageable from the latch 25 and the pawl 33, includes a pawl engagement portion 39, a latch engagement portion 40, and a latch-release urging portion 41. The block lever 38 may be formed of a metal, for example.

A metal block lever support shaft 37 penetrates a portion of the base member 21 in the front-and-rear direction. Then, the block lever support shaft 37 supports the block lever 38 so as to enable relative rotation thereof. The position of the block lever 38 in front-and-rear direction is the same as the position of the latch 25 and the pawl 33 in the front-and-rear direction. The block lever 38 is rotatable relative to the base member 21 around the block lever support shaft 37 between a rotation restriction position (see solid lines in FIGS. 5 and 6 and FIGS. 2 and 7) and a rotation non-restriction position (see dotted lines in FIGS. 5 and 6).

The outer peripheral surface of the latch engagement portion 40 is an arc-shaped surface 40a, the center of curvature of which is an axis 37C of the block lever support shaft 37. In addition, the outer peripheral surface of the pawl engagement portion 39 is an arc-shaped surface 40b, the center of curvature of which is the axis 37C of the block lever support shaft 37.

In addition, a torsion coil spring S3 (block lever urging element) illustrated in FIG. 2 is mounted between the block lever 38 and the base member 21. The block lever 38 is urged to rotate toward the rotation restriction position (the direction of arrow A3 in FIG. 2) by the urging force generated by the torsion coil spring S3. In addition, a block lever stopper (not illustrated) is provided on the base member 21. When the block lever 38, rotated by the urging force generated by the torsion coil spring S3, comes into contact with the block lever stopper, the block lever 38 is located at the rotation restriction position.

A first rotational trace CL1, indicated by a one-dot dashed line in FIGS. 2, 5, and 6, is the rotational trace of the outer peripheral surface of the portion in which the disengagement groove 28 of the latch 25 is formed. Meanwhile, a second rotational trace CL2, indicated by a one-dot dashed line, is the rotational trace of the outer peripheral surface of the portion in which the full-latch engagement target portion 27 of the latch 25 is formed.

Even when the pawl 33 is located at any position between the engagement position and the non-engagement position, the pawl 33 is located at the outer peripheral side of the first rotational trace CL1. That is, when the latch 25 rotates, the first urging portion 25a of the latch 25 does not interfere with the pawl 33.

Meanwhile, when the pawl 33 is located at the engagement position, the engagement protrusion 34 of the pawl 33 is located at the inner peripheral side of the second rotational trace CL2. That is, when the latch 25 rotates, the full-latch engagement target portion 27 (a portion of the outer peripheral portion) of the latch 25 interferes with the engagement protrusion 34 of the pawl 33 located at the engagement position.

When the block lever 38 is located at the rotation restriction position, the latch engagement portion 40 of the block lever 38 is located at the inner peripheral side of the first rotational trace CL1. That is, when the latch 25 rotates, the first urging portion 25a of the latch 25 interferes with the block lever 38 located at the rotation restriction position. Meanwhile, when the block lever 38 is located at the rotation non-restriction position, the latch engagement portion 40 of the block lever 38 is located at the outer peripheral side of the first rotational trace CL1. That is, when the latch 25 rotates, the first urging portion 25a of the latch 25 does not interfere with the block lever 38 located at the rotation non-restriction position.

When the block lever 38 is located at the rotation restriction position, the latch engagement portion 40 of the block lever 38 is located at the inner peripheral side of the second rotational trace CL2. That is, when the latch 25 rotates, the full-latch engagement target portion 27 (a portion of the outer peripheral portion) of the latch 25 interferes with the block lever 38 located at the rotation restriction position.

The lift lever 43, which is illustrated in FIGS. 3, 4, and 8 and is located in front of the latch 25, the pawl 33, and the block lever 38, is formed of a metal. However, the lift lever 43 may be formed of a resin.

An urging target portion 44 is provided on the end portion of the lift lever 43 on the vehicle inner side so as to protrude forward.

In addition, a cancel protrusion 45 is provided on the end portion of the lift lever 43 on the vehicle outer side so as to protrude forward.

Then, the block lever support shaft 37 supports the lift lever 43 so as to enable relative rotation thereof. In addition, a connection protrusion (not illustrated) of the lift lever 43 is fixed to the block lever 38 so as to pass rearward through a communication through-hole (not illustrated) formed in the base member 21. Therefore, the block lever 38 and the lift lever 43 rotate together around the block lever support shaft 37 between the rotation restriction position and the rotation non-restriction position.

As illustrated in FIGS. 3, 4, and 8, the outside open lever 47, which is located in front of the latch 25, the pawl 33, and the block lever 38, includes a support hole 48 and a rod connecting portion 49. The outside open lever 47 is formed of a metal. However, the outside open lever 47 may be formed of a resin.

A center portion of the outside open lever 47 is rotatably supported by the open lever support portion 24 of the base member 21.

A lower end portion of a rod (not illustrated), which is a hard metal member, is connected to the rod connecting portion 49 of the outside open lever 47, and an upper end portion of the rod is connected to the outside handle 17 via another member. Thus, the outside open lever 47 and the outside handle 17 are linked to each other. When the outside handle 17 is located at an initial position, the outside open lever 47 is located at an initial position (first position) (position in FIGS. 3, 4, and 8), and when the outside handle 17 is located at a latch release position, the outside open lever 47 is located at a latch release position (second position) (not illustrated). When the outside open lever 47 is rotated from the initial position by a predetermined angle in the counterclockwise direction of FIGS. 3, 4, and 8, the outside open lever 47 reaches the latch release position.

In addition, a torsion coil spring S4 illustrated in FIG. 3 is mounted between the base member 21 and the outside open lever 47. By the urging force generated by the torsion coil spring S4, the outside open lever 47 is urged to rotate toward the initial position (the direction of arrow A4 in FIG. 3), and the outside handle 17 is also urged to rotate toward the initial position.

As illustrated in FIGS. 3, 4, and 8, the open link 51 includes a supporting target portion 52 and an urging portion 53.

In addition, a substantially arc-shaped urging target surface 54 is formed on a portion of the outer peripheral surface of the open link 51.

The open link 51 is formed of a metal. However, the open link 51 may be formed of a resin.

The supporting target portion 52 of the open link 51 is supported in the support hole 48 in the outside open lever 47 so as to enable relative rotation thereof.

A torsion coil spring S5 illustrated in FIG. 3 is provided between the open link 51 and the outside open lever 47. The torsion coil spring S5 continuously urges the open link 51 relative to the outside open lever 47 so as to rotate in the direction of arrow A5 in FIG. 3.

The position of the urging portion 53 of the open link 51 in the front-and-rear direction is the same as that of the urging target portion 44 of the lift lever 43. As will be described later, the urging portion 53 of the open link 51 is disengageable from the urging target portion 44 of the lift lever 43.

In addition, the position of the urging target surface 54 of the open link 51 in the front-and-rear direction is the same as that of the cancel protrusion 45 of the lift lever 43. As will be described later, the urging target surface 54 of the open link 51 is disengageable from the cancel protrusion 45 of the lift lever 43.

In addition, the door lock device 20 includes an active lever (not illustrated).

The active lever is a lever that is disengageable from the open link 51. The active lever is rotatable between a lock position and an unlock position.

The active lever and the lock knob 19 are associated with each other by an operation wire (not illustrated). Therefore, the lock knob 19 and the active lever are linked to each other. That is, when the lock knob 19 is located at the lock position, the active lever is located at the lock position. Meanwhile, when the lock knob 19 moves from the lock position to the unlock position, the active lever rotates to the unlock position.

Next, an operation of the door lock device 20 will be described.

When the vehicle door 10 is located at the completely opened position at which the vehicle door 10 opens the opening formed in the side surface of the vehicle body, the door lock device 20 enters the state illustrated in FIG. 2. That is, the door lock device 20 enters an “unlatched state” where the latch 25 is located at the unlatch position, the pawl 33 is located at the engagement position, and the block lever 38 is located at the rotation restriction position.

When rotating the vehicle door 10 located at the completely opened position toward the opening, before the vehicle door 10 reaches the completely closed position at which the vehicle door 10 completely closes the opening, as illustrated in FIG. 2, the striker 100 fixed to the vehicle body is introduced into the striker introduction groove 22 of the base member 21.

When further rotating the vehicle door 10 toward the opening, the striker 100 is engaged with the striker holding groove 26, thereby rotating the latch 25 toward the full latch position against the urging force of the torsion coil spring S1.

Then, when the vehicle door 10 reaches the vicinity of the completely closed position that is just before the completely closed position, the latch 25 reaches the half latch position illustrated in FIG. 5, so that the first urging portion 25a urges the latch engagement portion 40 so as to temporarily rotate the block lever 38 toward the rotation non-restriction position. Then, when the block lever 38 returns to the rotation restriction position by the urging force of the torsion coil spring S3, the half-latch engagement portion 28b formed in the disengagement groove 28 of the latch 25 is engaged with the arc-shaped surface 40a of the latch engagement portion 40 of the block lever 38. When the rotational force of the vehicle door 10 is small at this time, the block lever 38 engaged with the latch 25 (the half-latch engagement portion 28b) stops at the rotation restriction position, rather than being rotated toward the rotation non-restriction position as when engaged with the latch 25. That is, a rotational position of the latch 25 is held at the half latch position by the block lever 38. In other words, the door lock device 20 enters a “half latched state”.

At this time, a force, indicated by arrow F1 illustrated in FIG. 5, is applied from the half-latch engagement portion 28b of the latch 25 to the arc-shaped surface 40a of the latch engagement portion 40 of the block lever 38. However, this force F1 passes through the axis 37C of the block lever support shaft 37 (the center of curvature of the arc-shaped surface 40a). Thus, no rotational moment is generated in the block lever 38 by the force F1.

In addition, at this time, the pawl engagement portion 39 (arc-shaped surface 40b) of the block lever 38 and the engagement protrusion 34 of the pawl 33 come into contact with each other.

When applying a force to the vehicle door 10 so as to further rotate the vehicle door 10 toward the completely closed position after the door lock device 20 enters the half latched state, the second urging portion 28a formed in the disengagement groove 28 of the latch 25 is engaged with the latch engagement portion 40 of the block lever 38 so as to rotate the block lever 38 (and the lift lever 43) toward the rotation non-restriction position (see the dotted line in FIG. 5) against the urging force of the torsion coil spring S3. Therefore, as illustrated in FIG. 6, the latch 25 rotates to the full latch position, and the vehicle door 10 reaches the completely closed position at which the vehicle door 10 completely closes the opening. In addition, when the latch 25 rotates toward the full latch position beyond the half latch position, since the second urging portion 28a of the latch 25 becomes farther away from the latch engagement portion 40 of the block lever 38, the block lever 38 (and the lift lever 43) rotates to return to the rotation restriction position by the urging force of the torsion coil spring S3.

In addition, in a case where the vehicle door 10 located at the completely opened position is rotated with a strong force, when the latch 25 reaches the half latch position, the latch 25 (the first urging portion 25a) is engaged with the latch engagement portion 40 of the block lever 38, thereby rotating the block lever 38 (and the lift lever 43) toward the rotation non-restriction position against the urging force of the torsion coil spring S3. Therefore, the latch 25 rotates to the full latch position without stopping the rotation thereof at the half latch position. In addition, when the latch 25 rotates toward the full latch position beyond the half latch position, since the latch 25 becomes farther away from the latch engagement portion 40 of the block lever 38, the block lever 38 (and the lift lever 43) rotates to return to the rotation restriction position by the urging force of the torsion coil spring S3.

In addition, while the latch 25 rotates from the half latch position to the full latch position, the full-latch engagement target portion 27 of the latch 25 interferes with the engagement protrusion 34 of the pawl 33 located at the engagement position. Therefore, the pawl 33 rotates toward the non-engagement position against the urging force of the torsion coil spring S2 (see the dotted line in FIG. 5). Then, when the full-latch engagement target portion 27 of the latch 25 passes over the engagement protrusion 34 of the pawl 33 and rotates toward the full latch position, the pawl 33 rotates to return to the engagement position by the urging force of the torsion coil spring S2 (see a solid line in FIG. 6). Then, when the latch 25 reaches the full latch position, the arc-shaped surface 34a of the engagement protrusion 34 of the pawl 33 is engaged with the full-latch engagement target portion 27 of the latch 25. That is, the engagement protrusion 34 of the pawl 33 restricts the rotation of the latch 25 toward the unlatch position.

In addition, the pawl engagement portion 39 (the arc-shaped surface 40b) of the block lever 38, rotated to return to the rotation restriction position, is engaged with the engagement protrusion 34 of the pawl 33 from below. That is, the pawl engagement portion 39 of the block lever 38 restricts the rotation of the pawl 33 toward the non-engagement position.

Accordingly, the door lock device 20 enters a “fully latched state” where the latch 25 engaged with the striker 100 is located at the latch position, the pawl 33 is located at the engagement position, and the block lever 38 is located at the rotation restriction position. Therefore, the vehicle door 10 is held at the completely closed position by the door lock device 20.

When the lock knob 19 is located at the lock position in a case where the vehicle door 10 is located at the completely closed position, the open link 51 is located at a latch unreleasable position (see FIG. 3) relative to the open lever 55 against the urging force of the torsion coil spring S5 by the action of the active lever. Then, the urging portion 53 of the open link 51 is located below the urging target portion 44 of the lift lever 43 on the vehicle outer side.

Accordingly, in this state, for example, when the outside handle 17 is operated to rotate from the initial position toward the latch release position, the outside open lever 47, which has been located at the initial position, rotates by a predetermined angle in the counterclockwise direction of FIG. 3, thereby reaching the latch release position. That is, the support hole 48 in the outside open lever 47 moves upward from the position in FIG. 3. Then, the open link 51 supported by the outside open lever 47 moves upward. However, since the urging portion 53 is located on the vehicle outer side of the urging target portion 44 of the lift lever 43, the urging portion 53 of the open link 51 is not engaged with the urging target portion 44 of the lift lever 43. Thus, even if the outside handle 17 rotates to the latch release position, the lift lever 43 and the block lever 38 remain at the rotation restriction position. Therefore, since the pawl 33 stops at the engagement position, the latch 25, the pawl 33, and the lift lever 43 maintain the fully latched state.

Meanwhile, when the lock knob 19 is located at the unlock position in a case where the vehicle door 10 is located at the completely closed position, the open link 51, which is guided by the active lever located at the unlock position and receives the urging force of the torsion coil spring S5, rotates relative to the outside open lever 47 in the clockwise direction of FIG. 3 to move to a latch releasable position (see FIG. 4). Therefore, the urging portion 53 of the open link 51 is located immediately under the urging target portion 44 of the lift lever 43.

In this case, when the outside handle 17 is operated so as to rotate from the initial position toward the latch release position, since the outside open lever 47 rotates toward the latch release position, the open link 51 located at the latch releasable position moves upward, so that the urging portion 53 of the open link 51 is engaged with the urging target portion 44 of the lift lever 43. Then, when the outside handle 17 and the outside open lever 47 reach the latch release position, the lift lever 43, the urging target portion 44 of which is urged upward by the urging portion 53 of the open link 51, and the block lever 38 rotate to the rotation non-restriction position (see the dotted line in FIG. 6).

Thereby, the pawl engagement portion 39 of the block lever 38 is spaced apart from the engagement protrusion 34 of the pawl 33. Then, since the vehicle door 10 rotates toward the completely opened position by a predetermined reaction force (e.g., a force generated by a weather strip, which is formed of an elastic material and is fixed to the outer peripheral surface of the vehicle door 10), the latch 25 rotates in the clockwise direction of FIGS. 6 and 7 while being engaged with the striker 100. As a result, the pawl 33 pushed by the latch 25 automatically rotates to the non-engagement position (see the dotted line in FIG. 6). Thereby, since the engagement protrusion 34 of the pawl 33 is spaced apart from the full-latch engagement target portion 27 of the latch 25, the latch 25 rotates toward the unlatch position when the vehicle door 10 is rotated toward the completely opened position.

In addition, when the vehicle door 10 rotates to the completely opened position by the reaction force, the pawl 33 may not rotate toward the non-engagement position due to the rotational force of the latch 25 for some reasons. However, in this case, the latch-release urging portion 41 of the block lever 38 comes into contact with the urging target portion 35 of the pawl 33 located at the engagement position, thereby rotating the pawl 33 (the urging target portion 35) to the non-engagement position against the urging force of the torsion coil spring S2 (see the dotted line in FIG. 6).

Then, when the vehicle door 10 is rotated toward the completely opened position until the striker 100 is spaced apart from the latch 25, the latch 25 is located at the unlatch position by the urging force of the torsion coil spring S1. In addition, the pawl 33 is rotated to return to the engagement position by the urging force of the torsion coil spring S2, and the block lever 38 is also rotated to return to the rotation restriction position by the urging force of the torsion coil spring S3. That is, the door lock device 20 enters the unlatched state, so that the vehicle door 10 is rotatable to the completely opened position.

However, when the door lock device 20 is in the fully latched state, as illustrated in FIG. 7, a force fa is applied from the latch 25 to the arc-shaped surface 34a of the pawl 33. Therefore, this force fa passes through the center of curvature 34aC. Therefore, at this time, a static frictional force Fa=faxμa is generated at the contact point between the latch 25 and the pawl 33. In addition, “μa” is the coefficient of static friction between the latch 25 and the pawl 33. In addition, due to the force fa, a rotational moment M=faxRa is generated in the pawl 33. In addition, “Ra” is a distance between a straight line that extends in the direction of the force fa and a straight line that passes through the axis 30C of the pawl support shaft 30 and also extends parallel to the force fa.

In addition, at this time, since the pawl 33 tries to rotate in the clockwise direction of FIG. 7 by the rotational moment M, a force fb is applied from the pawl 33 to the arc-shaped surface 40b of the block lever 38. Therefore, at this time, a static frictional force Fb=fbxμb is generated at the contact point between the pawl 33 and the block lever 38. In addition, “μb” is the coefficient of static friction between the pawl 33 and the block lever 38. Then, the force fb is determined by the rotational moment M and the distance Rb. Here, the distance Rb is a distance between a straight line that extends in the direction of the force fb and a straight line that passes through the axis 30C of the pawl support shaft 30 and also extends parallel to the force fb. In addition, since the center of curvature of the arc-shaped surface 40b is the axis 37C as described above, the force fb passes through the axis 37C. That is, the rotational moment M=fbxRb is established between M, fb, and Rb. Then, in the present embodiment, positions of the latch support shaft 23, the pawl support shaft 30, and the block lever support shaft 37 are set so that “Ra” is less than “Rb”. Then, since “μa” and “μb” are the same (or substantially the same), the force fa is greater than the force fb. That is, the static frictional force Fa is greater than the static frictional force Fb.

Here, a case where the door lock device 20 does not include the block lever 38 is assumed. In this case, when the door lock device 20 is in the fully latched state, it is necessary to release the contact between the latch 25 and the pawl 33 in order to release the fully latched state. Then, in order to rotate the pawl 33 so as to release the contact with the latch 25, it is necessary to rotate the pawl 33 with a force that overcomes the static frictional force Fa.

Meanwhile, in a case where the door lock device 20 includes the block lever 38 as in the present embodiment, in order to release the fully latched state of the door lock device 20, it is necessary to rotate the block lever 38 so as to release the contact between the pawl 33 and the block lever 38. That is, it is necessary to rotate the block lever 38 with a force that overcomes the static friction force Fb.

Then, as described above, the static frictional force Fa is greater than the static frictional force Fb. Therefore, it is possible to release the fully latched state of the door lock device 20 by rotating the block lever 38 with a small force (as compared with a case where the door lock device 20 does not include the block lever 38). In other words, it is possible to release the fully latched state of the door lock device 20 without increasing the force applied to the outside handle 17.

In addition, in a case where the open link 51 is located at the latch unreleasable position, when the vehicle door 10 located at the completely opened position is rotated to the completely closed position, the first urging portion 25a of the latch 25 does not interfere with the engagement protrusion 34 of the pawl 33 located at the engagement position, but comes into contact with the latch engagement portion 40 of the block lever 38 located at the rotation restriction position while the latch 25 engaged with the striker 100 rotates from the unlatch position to the half latch position. Therefore, as described above, the block lever 38 temporarily rotates to the rotation non-restriction position against the urging force of the torsion coil spring S3.

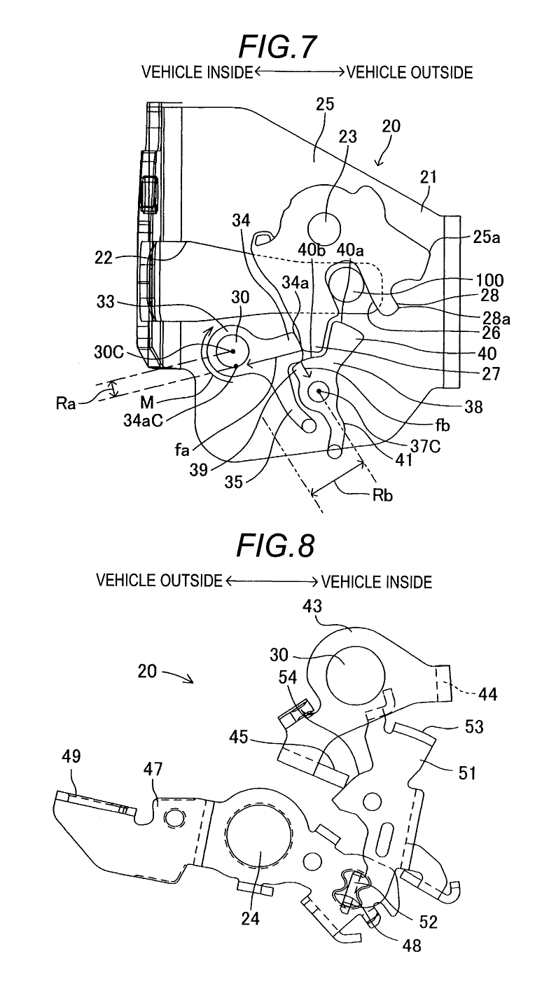

Therefore, as illustrated in FIG. 8, the cancel protrusion 45 of the lift lever 43, rotated toward the rotation non-restriction position together with the block lever 38, collides with the urging target surface 54 of the open link 51 located at the latch unreleasable position, thereby rotating the open link 51 to the latch releasable position. Thus, when the outside open lever 47 is thereafter moved to the latch release position by operating the outside handle 47 to rotate from the initial position to the latch release position, the latch 25, the pawl 33, and the block lever 38 are switched from the fully latched state to the unlatched state.

In addition, the lift lever 43 and the block lever 38, which have temporarily rotated toward the rotation non-restriction position, return thereafter to the rotation restriction position by the urging force of the torsion coil spring S3, as described above.

As described above, in the present embodiment, when the latch 25 is located at the full latch position, the pawl 33 is located at the engagement position so as to be engaged with the full-latch engagement target portion 27 of the latch 25, thereby holding the latch 25 at the full latch position. In addition, the block lever 38 is located at the rotation restriction position and is engaged with the pawl 33, thereby holding the pawl 33 at the engagement position.

Accordingly, the latch 25, located at the full latch position, may be firmly held at the full latch position by using two members (the pawl 33 and the block lever 38). Therefore, even if a great force in the opening direction is applied to the vehicle door 10 located at the completely closed position, there is little possibility of the vehicle door 10 being rotated.

In addition, the fully latched state of the door lock device 20 may be released by rotating the block lever 38 with a small force (as compared with a case where the door lock device 20 does not include the block lever 38). That is, although the latch 25 is firmly held at the full latch position by two members including the pawl 33 and the block lever 38, the fully latched state of the door lock device 20 may be released without increasing the force applied to the outside handle 17.

In addition, when the latch 25 is located at the half latch position, the latch engagement portion 40 (the arc-shaped surface 40a) of the block lever 38 is located at the rotation restriction position (the half-latch holding position) and is engaged with the half-latch engagement portion 28b of the latch 25, thereby holding the latch 25 at the half latch position.

At this time, the engagement protrusion 34 of the pawl 33 located at the engagement position and the pawl engagement portion 39 of the block lever 38 located at the rotation restriction position come into contact with each other. However, the pawl 33, urged to rotate by the torsion coil spring S2, is located at the engagement position by coming into contact with the pawl stopper. That is, at this time, the rotational force in the clockwise direction of FIG. 5, generated by the pawl 33, is substantially zero. Thus, at this time, the pawl 33 does not substantially function as a stopper that restricts the rotation of the block lever 38 toward the rotation non-restriction position. That is, when the latch 25 is located at the half latch position, the latch 25 is held at the half latch position by using substantially only the block lever 38 and the torsion coil spring S3.

However, at this time, as described above, no rotational moment is generated in the block lever 38 by the force F1 that is applied from the half-latch engagement portion 28b of the latch 25 to the arc-shaped surface 40a of the latch engagement portion 40 of the block lever 38.

Accordingly, it is possible to reliably hold the latch 25 at the half latch position by using only the block lever 38 and the torsion coil spring S3.

In addition, as compared with a case where the latch 25 is held at the half latch position by using the pawl 33 and the block lever 38, the latch 25 may be highly precisely held at the half latch position. In addition, in a case where a rotational moment having a certain magnitude is generated in the block lever 38 due to the force applied from the pawl 33 to the block lever 38 when the latch 25 is located at the half latch position (i.e., in a case where the latch 25 is held at the half latch position by using substantially two members including the block lever 38 and the pawl 33), it is difficult to highly precisely position the block lever 38 at the rotation restriction position. That is, in this case, it is difficult to highly precisely hold the latch 25 at the half latch position.

In addition, the block lever 38 includes the latch-release urging portion 41. Therefore, when the block lever 38 is rotated from the rotation restriction position toward the rotation non-restriction position in a case where the door lock device 20 is in the fully latched state, it is possible to reliably rotate the pawl 33 from the engagement position to the non-engagement position, even when the pawl 33 is not rotated toward the non-engagement position by the latch 25 of the vehicle door 10 rotated toward the completely opened position by the reaction force. That is, as compared with a case where the block lever 38 does not include the latch-release urging portion 41, it is possible to reliably shift the door lock device 20 from the fully latched state to the unlatched state.

In addition, when the latch 25 rotates from the unlatch position to the half latch position, the first urging portion 25a of the latch 25 does not interfere with the engagement protrusion 34 of the pawl 33 located at the engagement position, and comes into contact with the latch engagement portion 40 of the block lever 38 located at the rotation restriction position. Therefore, at this time, the block lever 38 reliably rotates toward the rotation non-restriction position against the urging force of the torsion coil spring S3. Therefore, the cancel protrusion 45 of the lift lever 43, which rotates together with the block lever 38 toward the rotation non-restriction position, may reliably rotate the open link 51, located at the latch unreleasable position, to the latch releasable position.

In addition, when the first urging portion 25a of the latch 25 interferes with the engagement protrusion 34 of the pawl 33 located at the engagement position while the latch 25 rotates from the unlatch position to the half latch position, the pawl 33, rotated by the latch 25, rotates and comes into contact with the block lever 38. When such a situation occurs, there is a possibility that the block lever 38 may not smoothly rotate to the rotation non-restriction position against the urging force of the torsion coil spring S3. In other words, there is possibility that the cancel protrusion 45 of the lift lever 43 may not rotate the open link 51, located at the latch unreleasable position, to the latch releasable position.

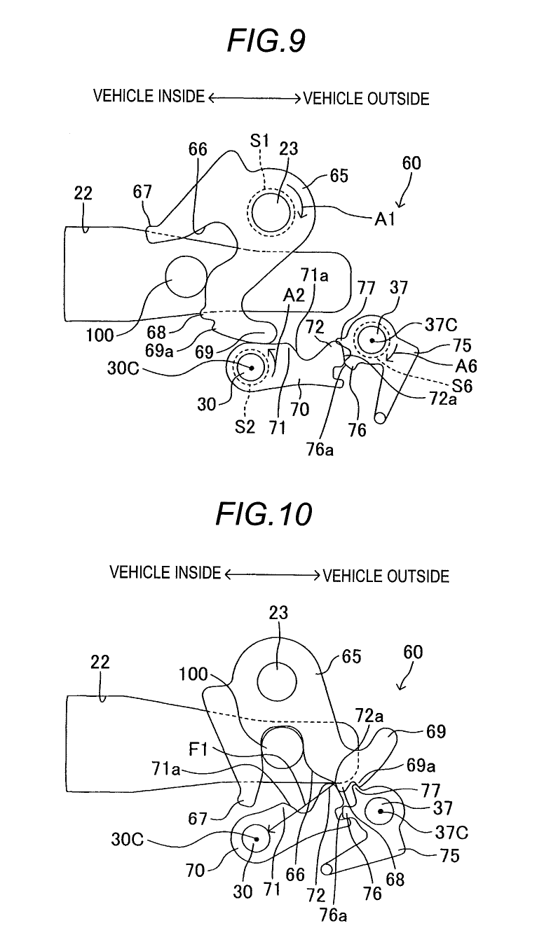

Next, a second embodiment disclosed here will be described with reference to FIGS. 9 to 11. In addition, the same reference numerals will be given to the same members as those in the first embodiment, and a detailed description thereof will be omitted.

A door lock device 60 of the present embodiment includes a latch 65, a pawl 70, and a block lever 75, which are rotatably supported on the base member 21. In addition, the door lock device 60 includes the outside open lever 47, the lift lever 43, and the open link 51, which are rotatably supported on the open lever support portion 24 of the base member 21. However, in FIGS. 9 to 11, illustration of the lift lever 43, the outside open lever 47, and the open link 51 is omitted.

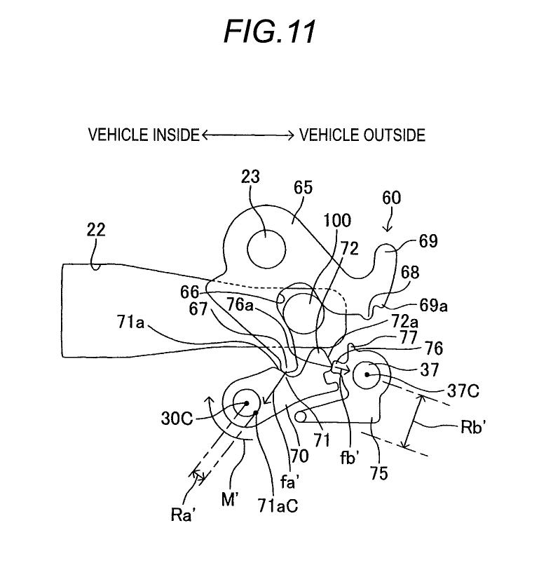

The latch 65 includes a striker holding groove 66 into which the striker 100 may be introduced, a full-latch engagement target portion 67, a first half-latch engagement target portion 68 (half-latch engagement target portion), and a rotation restriction protrusion 69. In addition, the proximal end portion of the rotation restriction protrusion 69 is configured with a second half-latch engagement target portion 69a (half-latch engagement target portion). The material of the latch 65 is the same as that of the latch 25. The latch 65 is rotatably supported on the latch support shaft 23. The latch 65 is rotatable relative to the base member 21 between a full latch position (see FIG. 11) at which the striker holding groove 66 is engaged with the striker 100 and an unlatch position (see FIG. 9) at which the striker holding groove 66 releases the striker 100. In addition, when rotating between the unlatch position and the full latch position, the latch 65 passes through a half latch position (see FIG. 10) located between the unlatch position and the full latch position.

In addition, the torsion coil spring S1 is provided between the latch 65 and the base member 21 to urge the latch 65 to rotate toward the unlatch position (the direction of arrow A1 in FIG. 9).

The pawl 70, which is disengageable from the latch 65, includes a full-latch engagement portion 71 and a half-latch engagement portion 72. The material of the pawl 70 is the same as that of the pawl 33. The pawl 70 is rotatably supported on the pawl support shaft 30. The latch 65 and the pawl 70 have the same position in the front-and-rear direction.

The pawl 70 is rotatable around the pawl support shaft 30 relative to the base member 21 between an engagement position (see FIGS. 10 and 11) at which the full-latch engagement portion 71 is engaged with the full-latch engagement target portion 67 of the latch 65 located at the full latch position to hold the latch 65 at the full latch position and a non-engagement position (see FIG. 9).

As illustrated in FIGS. 9 to 11, the outer peripheral surface of the full-latch engagement portion 71 is configured with an arc-shaped surface 71a. The center of curvature 71aC of the arc-shaped surface 71a is spaced apart from the axis 30C of the pawl support shaft 30 by a predetermined distance (distance Ra′ to be described later) (see FIG. 11). In addition, the center of curvature of the arc-shaped surface 72a of the half-latch engagement portion 72 is the axis 30C.

In addition, the torsion coil spring S2 is provided between the pawl 70 and the base member 21 to urge the pawl 70 to rotate toward the engagement position (the direction of arrow A2 in FIG. 9).

In addition, a pawl stopper (not illustrated) is provided on the base member 21. Then, the pawl 70, urged to rotate by the torsion coil spring S2, comes into contact with the pawl stopper, so that the rotation of the pawl 70 is restricted at the engagement position.

The block lever 75, which is disengageable from the latch 65 and the pawl 70, includes a pawl engagement portion 76 and a latch engagement portion 77. The outer peripheral surface of the pawl engagement portion 76 is an arc-shaped surface 76a, the center of curvature of which is the axis 37C of the block lever support shaft 37. The material of the block lever 75 is the same as that of the block lever 38. The block lever 75 is rotatably supported on the block lever support shaft 37. The position of the block lever 75 in the front-and-rear direction is the same as the position of the latch 65 and the pawl 70 in the front-and-rear direction.

The block lever 75 is rotatable relative to the base member 21 between a rotation restriction position (see FIG. 11) and a rotation non-restriction position (see FIG. 9). In addition, when rotating between the rotation restriction position and the rotation non-restriction position, the block lever 75 passes through a half-latch engagement position (see FIG. 10).

In addition, a torsion coil spring S6 is provided between the block lever 75 and the base member 21 to urge the block lever 75 to rotate toward the rotation restriction position (the direction of arrow A6 in FIG. 9).

The lift lever 43 is fixed to the block lever 75 via the connection protrusion, which passes through the communication through-hole formed in the base member 21. Therefore, the block lever 75 and the lift lever 43 rotate together around the block lever support shaft 37 between the rotation restriction position and the rotation non-restriction position.

Next, an operation of the door lock device 60 will be described.

When the vehicle door 10 is located at a completely opened position, the door lock device 60 enters the state illustrated in FIG. 9. That is, the door lock device 60 enters an “unlatched state” where the latch 65 is located at the unlatch position, the pawl 70 is located at the non-engagement position, and the block lever 75 is located at the rotation non-restriction position. At this time, the pawl 70, urged to rotate by the urging force of the torsion coil spring S2, is positioned at the non-engagement position by coming into contact with the rotation restriction protrusion 69. In addition, the block lever 75, urged to rotate by the urging force of the torsion coil spring S6, is located at the rotation non-restriction position by coming into contact at the pawl engagement portion 76 thereof with the pawl 70.

When rotating the vehicle door 10 located at the completely opened position toward the opening, before the vehicle door 10 reaches a completely closed position, as illustrated in FIG. 9, the striker 100 fixed to the vehicle body is introduced into the striker introduction groove 22 of the base member 21.

When further rotating the vehicle door 10 toward the opening, the striker 100 is engaged with the striker holding groove 66, thereby rotating the latch 65 toward the full latch position against the urging force of the torsion coil spring S1. Then, the rotation restriction protrusion 69 of the latch 65 is rotated by coming into contact with the surface of the pawl 70 that faces the latch 65, and consequently, the rotation restriction protrusion 69 is spaced apart from the pawl 70. Thereby, the pawl 70 is rotated toward the engagement position by the urging force of the torsion coil spring S2, thereby temporarily releasing the engagement with the block lever 75 (the pawl engagement portion 76). Accordingly, the block lever 75, urged to rotate by the urging force of the torsion coil spring S6, rotates toward the half-latch engagement position.

Then, when the vehicle door 10 reaches the vicinity of the completely closed position that is just before the completely closed position, the latch 65 reaches the half latch position illustrated in FIG. 10, so that the first half-latch engagement target portion 68 of the latch 65 is engaged with the half-latch engagement portion 72 of the pawl 70. In addition, the latch engagement portion 77 of the block lever 75, rotated to the half-latch engagement position, is engaged with the second half-latch engagement target portion 69a of the latch 65. Meanwhile, the pawl engagement portion 76 of the block lever 75 is spaced apart from the pawl 70.

When the rotational force of the vehicle door 10 is small at this time, the pawl 70 and the block lever 75, which are engaged with the latch 65, stop at the position illustrated in FIG. 10. In other words, the pawl 70 is not rotated toward the non-engagement position, and the block lever 75 is also not rotated toward the rotation non-restriction position. That is, the rotational position of the latch 65 is held at the half latch position by the pawl 70 and the block lever 75. In other words, the door lock device 60 enters the “half latched state”.

At this time, a force, indicated by arrow F1 illustrated in FIG. 10, is applied from the first half-latch engagement target portion 68 of the latch 65 to the arc-shaped surface 72a of the half-latch engagement portion 72 of the pawl 70. However, this force F1 passes through the axis 30C of the pawl 70. Thus, no rotational moment is generated in the pawl 70 by the force F1.

When applying a force to the vehicle door 10 so as to further rotate the vehicle door 10 toward the completely closed position after the door lock device 60 enters the half latched state, the first half-latch engagement target portion 68 of the latch 65 is spaced apart from the half-latch engagement portion of the pawl 70. In addition, the first half-latch engagement target portion 68 of the latch 65 urges and passes over the latch engagement portion 77 of the block lever 75, so that the latch 65 rotates to the full latch position.

In addition, in a case where the vehicle door 10 located at the completely opened position is rotated with a strong force, when the latch 65 reaches the half latch position, the first half-latch engagement target portion 68 of the latch 65 is spaced apart from the half-latch engagement portion 72 of the pawl 70, and the first half-latch engagement target portion 68 of the latch 65 urges and passes over the latch engagement portion 77 of the block lever 75. Therefore, the latch 25 rotates to the full latch position without stopping the rotation thereof at the half latch position.

In addition, while the latch 65 rotates from the half latch position to the full latch position, the latch 65 rotates while temporarily urging the pawl 70 to the non-engagement position by the full-latch engagement target portion 67, and then rotates to the full latch position illustrated in FIG. 11 when the vehicle door 10 reaches the completely closed position at which the vehicle door 10 completely closes the opening.

Thereby, the arc-shaped surface 71a of the full-latch engagement portion 71 of the pawl 70, rotated to return to the engagement position by the urging force of the torsion coil spring S2, is engaged with the full-latch engagement target portion 67. That is, the arc-shaped surface 71a of the full-latch engagement portion 71 of the pawl 70 restricts the rotation of the latch 65 toward the unlatch position.

In addition, the block lever 75, which receives the urging force of the torsion coil spring S6, rotates to the rotation restriction position, and the pawl engagement portion 76 (the arc-shaped surface 76a) is engaged with the half-latch engagement portion 72 of the pawl 70. That is, the pawl engagement portion 76 of the block lever 75 restricts the rotation of the pawl 70 toward the non-engagement position.

Accordingly, the door lock device 60 enters a “fully latched state” where the latch 65 engaged with the striker 100 is located at the latch position, the pawl 70 is located at the engagement position, and the block lever 75 is located at the rotation restriction position. Therefore, the vehicle door 10 is held at the completely closed position by the door lock device 60.

When the outside handle 17 is operated so as to rotate from the initial position toward the latch release position in a state where the vehicle door 10 is located at the completely closed position and the lock knob 19 is located at the unlock position, the outside open lever 47 rotates toward the latch release position. Then, when the outside handle 17 and the outside open lever 47 reach the latch release position, the lift lever 43, the urging target portion 44 of which is urged upward by the urging portion 53 of the open link 51, and the block lever 75 rotate to the rotation non-restriction position.

Thereby, the pawl engagement portion 76 of the block lever 75 is spaced apart from the half-latch engagement portion 72 of the pawl 70. That is, the restriction of rotation of the pawl 70 toward the non-engagement position by the block lever 75 is released. Then, since the vehicle door 10 is rotated toward the completely opened position by the reaction force, the latch 65 rotates in the clockwise direction of FIGS. 9 to 11 while being engaged with the striker 100. As a result, the pawl 70 pushed by the latch 65 automatically rotates toward the non-engagement position (not illustrated).

Then, when the vehicle door 10 is rotated toward the completely opened position until the striker 100 is spaced apart from the latch 65, the latch 65 is located at the unlatch position by the urging force of the torsion coil spring S1. In addition, the pawl 70 urged by the latch 65 rotates to return to the non-engagement position against the urging force of the torsion coil spring S2, and the block lever 75 rotates to return to the rotation non-restriction position. That is, the door lock device 60 enters the unlatched state, so that the vehicle door 10 is rotatable to the completely opened position.

However, when the door lock device 60 is in the fully latched state, as illustrated in FIG. 11, a force fa′ is applied from the latch 65 to the arc-shaped surface 71a of the pawl 70. Therefore, this force fa′ passes through the center of curvature 71aC. That is, a static frictional force Fa′=fa′xμa is generated at the contact point between the latch 65 and the pawl 70. In addition, “μa” is the coefficient of static friction between the latch 65 and the pawl 70. In addition, a rotational moment M′=fa′xRa′ is generated in the pawl 70 by the force fa′. In addition, “Ra′” is a distance between a straight line that extends in the direction of the force fa′ and a straight line that passes through the axis 30C of the pawl support shaft 30 and also extends parallel to the force fa′.

In addition, at this time, since the pawl 70 tries to rotate in the clockwise direction of FIG. 11 by the rotational moment M′, a force fb′ is applied from the pawl 70 to the arc-shaped surface 76a of the block lever 75. Therefore, at this time, a static frictional force Fb′=fb′xμb is generated at the contact point between the pawl 70 and the block lever 75. In addition, “μb” is the coefficient of static friction between the pawl 70 and the block lever 75. Then, the force fb′ is determined by the rotational moment M′ and a distance Rb′. Here, the distance Rb′ is a distance between a straight line that extends in the direction of the force fb′ and a straight line that passes through the axis 30C of the pawl support shaft 30 and also extends parallel to the force fb′. In addition, as described above, since the center of curvature of the arc-shaped surface 76a is the axis 37C, the force fb′ passes through the axis 37C. That is, a rotational moment M′=fb′xRb′ is established between M′, fb′, and Rb′. Then, in the present embodiment, positions of the latch support shaft 23, the pawl support shaft 30, and the block lever support shaft 37 are set so that “Ra′” is less than “Rb′”. Then, since “μa′” and “μb′” are the same (or substantially the same), the force fa′ is greater than the force fb′. That is, the static frictional force Fa′ is greater than the static frictional force Fb′.

Accordingly, as in the first embodiment, the fully latched state of the door lock device 60 may be released by rotating the block lever 75 with a small force (as compared with a case where the door lock device 60 does not include the block lever 75). In other words, the fully latched state of the door lock device 60 may be released without increasing the force applied to the outside handle 17.

As described above, in the present embodiment, similarly, when the latch 65 is located at the full latch position, the pawl 70 is located at the engagement position and is engaged with the full-latch engagement target portion 67 of the latch 65, thereby holding the latch 65 at the full latch position. In addition, the block lever 75 is located at the rotation restriction position and is engaged with the pawl 70, thereby holding the pawl 70 at the engagement position.

Accordingly, the latch 65 located at the full latch position may be firmly held at the full latch position by using two members (the pawl 70 and the block lever 75). Therefore, even if a great force in the opening direction is applied to the vehicle door 10 located at the completely closed position, there is little possibility of the vehicle door 10 being rotated.

In addition, the fully latched state of the door lock device 60 may be released by rotating the block lever 75 with a small force (as compared with a case where the door lock device 60 does not include the block lever 75). That is, although the latch 65 is firmly held at the full latch position by two members including the pawl 70 and the block lever 75, the fully latched state of the door lock device 60 may be released without increasing the force applied to the outside handle 17.

In addition, when the latch 65 is located at the half latch position, the pawl 70 (the half-latch engagement portion 72) is located at the engagement position (half-latch holding position) and is engaged with the first half-latch engagement target portion 68 of the latch 65, thereby holding the latch 65 at the half latch position.

Then, at this time, the block lever 75 is spaced apart from the pawl 70. That is, since the block lever 75 applies no force to the pawl 70, a rotational moment due to the block lever 75 is not generated in the pawl 70. Thus, at this time, the block lever 75 does not substantially function as a stopper that restricts the rotation of the pawl 70 toward the non-engagement position. That is, when the latch 65 is located at the half latch position, the latch 65 is held at the half latch position by using substantially only the pawl 70 and the torsion coil spring S2.

However, at this time, as described above, a rotational moment is not generated in the pawl 70 by the force F1, which is applied from the first half-latch engagement target portion 68 of the latch 65 to the arc-shaped surface 72a of the half-latch engagement portion 72 of the pawl 70.

Accordingly, the latch 65 may be reliably held at the half latch position by using only the pawl 70 and the torsion coil spring S2.

In addition, as compared with a case where the latch 65 is held at the half latch position by using the pawl 70 and the block lever 75, the latch 65 may be highly precisely held at the half latch position. In addition, in a case where a rotational moment having a certain magnitude is generated in the pawl 70 due to the force applied from the block lever 75 to the pawl 70 when the latch 65 is located at the half latch position (i.e., in a case where the latch 65 is held at the half latch position by using substantially two members including the pawl 70 and the block lever 75), it is difficult to highly precisely position the pawl 70 at the engagement position. That is, in this case, it is difficult to highly precisely hold the latch 65 at the half latch position.

Although the respective embodiments disclosed here have been described above, the disclosure is not limited to the above-described embodiments.

When the door lock device 20 of the first embodiment is in the half latched state, the force F1, which is applied to the block lever 38 by the latch 25 illustrated in FIG. 5, may be the force that passes through a position (hereinafter referred to as “spaced position”) that is spaced apart from the axis 37C of the block lever support shaft 37 to the left side of FIG. 5 by a slight distance.

In this case, a rotational moment generated in the block lever 38 by the force F1 assists the block lever 38 in being located at the rotation restriction position (half-latch holding position).

Similarly, when the door lock device 60 of the second embodiment is in the half latched state, the force, which is applied to the pawl 70 by the latch 65 illustrated in FIG. 10, may pass through a position (spaced position) that is spaced apart from the axis 30C of the pawl support shaft 30 to the upper side of FIG. 10 by a slight distance.

In this case, a rotational moment generated in the pawl 70 by this force F1 assists the pawl 70 in being located at the engagement position (half-latch holding position).

The pawl 30 and the block lever 38 may be spaced apart from each other when the door lock device 20 of the first embodiment is in the half latched state.

The door lock devices 20 and 60 may include an electric motor capable of exerting a driving force for rotating the block levers 38 and 75.

In addition, this disclosure may be applied to a vehicle door (e.g., a back door) different from the side door.

The lift lever 43 may be omitted. In this case, when the open link 51 is located at the latch releasable position and the outside open lever 47 is located at the latch release position, the open link 51 urges the block levers 38 and 75 to the rotation non-restriction position. In addition, in this case, the block levers 38 and 75 may be provided with the cancel protrusion 45.

The latch-release urging portion 41 may be formed on the block lever 75, and the urging target portion 35 may be formed on the pawl 70.

An inside handle (operation unit) may be rotatably provided on the trim of the vehicle door 10. The inside handle is associated with an inside open lever (open lever) via, for example, an operation wire. Then, when the inside handle is located at the initial position, the inside open lever is located at the initial position (the first position), and the inside open lever applies no force to the outside open lever 47. Meanwhile, when the inside handle moves from the initial position to the latch release position, the inside open lever moves to the latch release position (second position), and moves the outside open lever 47 to the latch release position.

An aspect of this disclosure is directed to a vehicle door lock device including a latch configured to be rotatable to a full latch position at which the latch is engaged with a striker attached to a vehicle body to hold a vehicle door in a closed state, an unlatch position at which the latch releases the striker to allow the vehicle door to enter an open state, and a half latch position which is a position between the full latch position and the unlatch position and at which the latch is engaged with the striker, a pawl configured to be rotatable between an engagement position at which the pawl is engaged with the latch located at the full latch position and a non-engagement position at which the pawl releases the engagement with the latch, and a block lever configured to be rotatable between a rotation restriction position at which the block lever is engaged with the pawl to hold the pawl at the engagement position and a rotation non-restriction position at which the block lever does not restrict the rotation of the pawl, wherein, when the latch is located at the half latch position, the latch is engaged with the block lever while applying a force in a direction that passes through a rotation axis of the block lever, or wherein, when the latch is located at the half latch position, the latch is engaged with the pawl while applying a force in a direction that passes through a rotation axis of the pawl.

The phrase “force in a direction that passes through a rotation axis of the block lever” includes a force that exactly passes through the rotation axis of the block lever and a force that passes through a position (hereinafter referred to as a “spaced position”) that is slightly spaced apart from the rotation axis of the block lever.

However, in a case where the force, applied to the block lever by the latch, passes through the spaced position, only when the direction of a rotational moment, generated in the block lever by this force, is the direction that maintains engagement between the block lever and the latch, this force becomes the “force that passes through the rotation axis of the block lever”. In other words, when the direction of the rotational moment, generated in the block lever by this force, is the direction that causes the block lever to be spaced apart from the latch, this force is not included in the “force that passes through the rotation axis of the block lever”.

Similarly, the phrase “force that passes through the rotation axis of the pawl” includes a force that exactly passes through the rotation axis of the pawl and a force that passes through a spaced position that is slightly spaced apart from the rotation axis of the pawl. However, in a case where the force, applied to the pawl by the latch, passes through the spaced position, only when the direction of a rotational moment generated in the pawl by this force is the direction that maintains engagement between the pawl and the latch, this force becomes the “force that passes through the rotation axis of the pawl”.

In the aspect of this disclosure, when the latch is at the full latch position, the pawl is located at the engagement position and is engaged with the latch, thereby holding the latch at the full latch position. In addition, the block lever is engaged with the pawl at the rotation restriction position, thereby holding the pawl at the engagement position.

Accordingly, the latch, located at the full latch position, can be firmly held at the full latch position by using two members (the pawl and the block lever).

Meanwhile, in a first mode in the aspect of this disclosure, when the latch is located at the half latch position, the block lever is engaged with the latch, thereby holding the latch at the half latch position. In addition, at that time, the latch is engaged with the block lever while applying the force in the direction that passes through the rotation axis of the block lever.

In addition, in a second mode in the aspect of this disclosure, when the latch is located at the half latch position, the pawl is engaged with the latch, thereby holding the latch at the half latch position. In addition, at this time, the latch is engaged with the pawl while applying the force in the direction that passes through the rotation axis of the pawl.

Thus, in either of the first and second aspects, when the latch is located at the half latch position, the latch comes into contact with the block lever or the pawl while applying the force in the direction that passes through the rotation axis of these members. Therefore, the block lever or the pawl, engaged with the latch, is not rotated in a direction, in which it is spaced apart from the latch, by the force received from the latch. Accordingly, it is unnecessary for another member to restrict the rotation of the block lever or the pawl, engaged with the latch, in a direction in which it releases the engagement with the latch.

Therefore, the latch can be highly precisely held at the half latch position by only one of the block lever and the pawl.

The block lever may include a latch-release urging portion configured to urge the pawl toward the non-engagement position when the block lever rotates toward the rotation non-restriction position in a state where the latch is located at the full latch position and the block lever is located at the rotation restriction position.

By configuring the aspect of this disclosure in the manner described above, when the block lever rotates toward the rotation non-restriction position in a state where the latch is located at the full latch position and the block lever is located at the rotation restriction position, the pawl located at the engagement position can be reliably moved toward the non-engagement position.

When the latch is located at the half latch position, the pawl may be spaced from the latch and the block lever is engaged with the latch to hold the latch at the half latch position, and the latch may maintain a non-contact state with the pawl when the latch rotates between the unlatch position and the half latch position.

By configuring the aspect of the invention in the manner described above, the latch does not come into contact the pawl when the latch rotates from the unlatch position to the half latch position. That is, when the latch rotates from the unlatch position to the half latch position, the pawl pushed by the latch does not urge the block lever. Therefore, when the latch rotates from the unlatch position to the half latch position, the block lever can easily perform a desired rotational operation.

Accordingly, when the latch is located at the half latch position, the black lever can be reliably moved to a position at which the block lever is engaged with the latch.

A radial distance from a rotation center shaft to a half-latch engagement target portion of the latch about the rotation axis may be shorter than a radial distance from the rotation center shaft to a full-latch engagement target portion of the latch, and the half-latch engagement target portion may maintain a non-contact state with the pawl when the latch rotates between the unlatch position and the half latch position.

By configuring the aspect of this disclosure in the manner described above, a structure for reliably moving the block lever to a position at which the block lever is engaged with the latch when the latch is located at the half latch position can be simplified.

The vehicle door lock device may further include an open lever configured to rotate between a first position and a second position, an open link supported on the open lever so as to be rotatable relative to the open lever between a latch unreleasable position and a latch releasable position, and a cancel protrusion provided on the block lever or on a rotator configured to rotate together with the block lever. The open link may not urge the block lever or the rotator irrespective of a position of the open lever in a case where the open link is located at the latch unreleasable position, and the open link urges the block lever, located at the rotation restriction position, or the rotator toward the rotation non-restriction position when the open lever moves from the first position to the second position in a case where the open link is located at the latch releasable position. As the vehicle door in the open state enters the closed state in a state where the open link is located at the latch unreleasable position, when the block lever is rotated toward the rotation non-restriction position by a force transmitted from the striker through the latch, the cancel protrusion may urge the open link located at the latch unreleasable position so as to rotate the open link to the latch releasable position.

By configuring the aspect of this disclosure in the manner described above, when the vehicle door in the open state enters the closed state in the state where the open link is located at the latch unreleasable position, the latch, which receives the force from the striker, rotates from the unlatch position toward the half latch position. Then, at this time, as described above, the block lever can easily perform a desired rotational operation. Accordingly, at this time, the cancel protrusion also easily performs a desired operation.

Therefore, when the block lever is rotated toward the rotation non-restriction position by the force transmitted from the striker through the latch after the vehicle door in the open state enters the closed state, the cancel protrusion provided on the block lever urges the open link located at the latch unreleasable position, thereby rotating the open link to the latch releasable position. Accordingly, when the open lever is thereafter moved from the first position to the second position, the open link urges the block lever, located at the rotation restriction position, or the rotator toward the rotation non-restriction position. Accordingly, the vehicle door can enter the open state.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a latch configured to be rotatable to a full latch position at which the latch is engaged with a striker attached to a vehicle body to hold a vehicle door in a closed state, an unlatch position at which the latch releases the striker to allow the vehicle door to enter an open state, and a half latch position which is a position between the full latch position and the unlatch position and at which the latch is engaged with the striker;
a pawl configured to be rotatable between an engagement position at which the pawl is engaged with the latch located at the full latch position and a non-engagement position at which the pawl releases the engagement with the latch; and
a block lever configured to be rotatable between a rotation restriction position at which the block lever is engaged with the pawl to hold the pawl at the engagement position and a rotation non-restriction position at which the block lever does not restrict the rotation of the pawl,
wherein, when the latch is located at the half latch position, the latch is engaged with the block lever while applying a force in a direction that passes through a rotation axis of the block lever, or
when the latch is located at the half latch position, the latch is engaged with the pawl while applying a force in a direction that passes through a rotation axis of the pawl.

2. The vehicle door lock device according to claim 1,
wherein the block lever includes a latch-release urging portion configured to urge the pawl toward the non-engagement position when the block lever rotates toward the rotation non-restriction position in a state where the latch is located at the full latch position and the block lever is located at the rotation restriction position.

3. The vehicle door lock device according to claim 1,
wherein, when the latch is located at the half latch position, the pawl is spaced from the latch and the block lever is engaged with the latch to hold the latch at the half latch position, and
the latch maintains a non-contact state with the pawl when the latch rotates between the unlatch position and the half latch position.

4. The vehicle door lock device according to claim 2,
wherein, when the latch is located at the half latch position, the pawl is spaced from the latch and the block lever is engaged with the latch to hold the latch at the half latch position, and
the latch maintains a non-contact state with the pawl when the latch rotates between the unlatch position and the half latch position.

5. The vehicle door lock device according to claim 3,
wherein a radial distance from a rotation center shaft to a half-latch engagement target portion of the latch about the rotation axis is shorter than a radial distance from the rotation center shaft to a full-latch engagement target portion of the latch, and
the half-latch engagement target portion maintains a non-contact state with the pawl when the latch rotates between the unlatch position and the half latch position.

6. The vehicle door lock device according to claim 4,
wherein a radial distance from a rotation center shaft to a half-latch engagement target portion of the latch about the rotation axis is shorter than a radial distance from the rotation center shaft to a full-latch engagement target portion of the latch, and
the half-latch engagement target portion maintains a non-contact state with the pawl when the latch rotates between the unlatch position and the half latch position.

7. The vehicle door lock device according to claim 3, further comprising:
an open lever configured to rotate between a first position and a second position;
an open link supported on the open lever so as to be rotatable relative to the open lever between a latch unreleasable position and a latch releasable position; and
a cancel protrusion provided on the block lever or on a rotator configured to rotate together with the block lever,
wherein the open link does not urge the block lever or the rotator irrespective of a position of the open lever in a case where the open link is located at the latch unreleasable position, and the open link urges the block lever, located at the rotation restriction position, or the rotator toward the rotation non-restriction position when the open lever moves from the first position to the second position in a case where the open link is located at the latch releasable position, and
as the vehicle door in the open state enters the closed state in a state where the open link is located at the latch unreleasable position, when the block lever is rotated toward the rotation non-restriction position by a force transmitted from the striker through the latch, the cancel protrusion urges the open link located at the latch unreleasable position so as to rotate the open link to the latch releasable position.

8. The vehicle door lock device according to claim 4, further comprising:
an open lever configured to rotate between a first position and a second position;
an open link supported on the open lever so as to be rotatable relative to the open lever between a latch unreleasable position and a latch releasable position; and
a cancel protrusion provided on the block lever or on a rotator configured to rotate together with the block lever,
wherein the open link does not urge the block lever or the rotator irrespective of a position of the open lever in a case where the open link is located at the latch unreleasable position, and the open link urges the block lever, located at the rotation restriction position, or the rotator toward the rotation non-restriction position when the open lever moves from the first position to the second position in a case where the open link is located at the latch releasable position, and
as the vehicle door in the open state enters the closed state in a state where the open link is located at the latch unreleasable position, when the block lever is rotated toward the rotation non-restriction position by a force transmitted from the striker through the latch, the cancel protrusion urges the open link located at the latch unreleasable position so as to rotate the open link to the latch releasable position.

9. The vehicle door lock device according to claim 5, further comprising:
an open lever configured to rotate between a first position and a second position;
an open link supported on the open lever so as to be rotatable relative to the open lever between a latch unreleasable position and a latch releasable position; and
a cancel protrusion provided on the block lever or on a rotator configured to rotate together with the block lever,
wherein the open link does not urge the block lever or the rotator irrespective of a position of the open lever in a case where the open link is located at the latch unreleasable position, and the open link urges the block lever, located at the rotation restriction position, or the rotator toward the rotation non-restriction position when the open lever moves from the first position to the second position in a case where the open link is located at the latch releasable position, and
as the vehicle door in the open state enters the closed state in a state where the open link is located at the latch unreleasable position, when the block lever is rotated toward the rotation non-restriction position by a force transmitted from the striker through the latch, the cancel protrusion urges the open link located at the latch unreleasable position so as to rotate the open link to the latch releasable position.

10. The vehicle door lock device according to claim 6, further comprising:
an open lever configured to rotate between a first position and a second position;
an open link supported on the open lever so as to be rotatable relative to the open lever between a latch unreleasable position and a latch releasable position; and
a cancel protrusion provided on the block lever or on a rotator configured to rotate together with the block lever,
wherein the open link does not urge the block lever or the rotator irrespective of a position of the open lever in a case where the open link is located at the latch unreleasable position, and the open link urges the block lever, located at the rotation restriction position, or the rotator toward the rotation non-restriction position when the open lever moves from the first position to the second position in a case where the open link is located at the latch releasable position, and
as the vehicle door in the open state enters the closed state in a state where the open link is located at the latch unreleasable position, when the block lever is rotated toward the rotation non-restriction position by a force transmitted from the striker through the latch, the cancel protrusion urges the open link located at the latch unreleasable position so as to rotate the open link to the latch releasable position.
